(19) United States
(12) Patent Application Publication
(10) Pub. No.: US 2020/0244853 A1
(43) Pub. Date: Jul. 30, 2020

(54) SENSOR DEVICE FOR A VEHICLE

(71) Applicant: Robert Bosch GmbH, Stuttgart (DE)

(72) Inventors: Adrian Severin Matusek, Stuttgart-Rohr (DE); Anke Mueller, Bietigheim (DE); Paulina Szczesny, Leonberg (DE)

(21) Appl. No.: 16/775,426

(22) Filed: Jan. 29, 2020

(30) Foreign Application Priority Data
Jan. 30, 2019 (DE) 102019201148.9

(51) Int. Cl. H04N 5/225

(52) U.S. Cl. CPC H04N 5/2257; B60R 2300/80; H04N 5/2252

(57) ABSTRACT

A sensor device for a vehicle for detecting vehicle dimensions and/or pieces of vehicle surroundings information and a method for manufacturing such a sensor device. The sensor device includes at least one sensor unit for measuring corresponding vehicle dimensions and/or pieces of vehicle surroundings information, and a housing which at least partially encloses the sensor unit, the housing being at least partially formed by a ceramic casting compound, so that the housing may be manufactured in an unpressurized casting step, with exemption of sensor surfaces of the sensor unit.

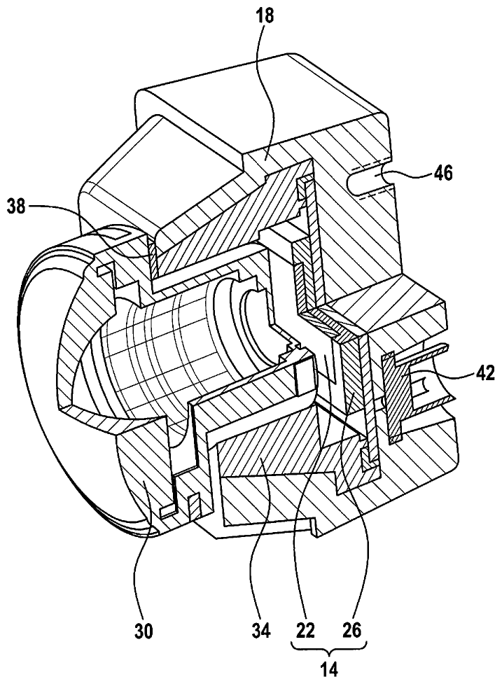

### CROSS REFERENCE

The present application claims the benefit under 35 U.S.C. § 119 of German Patent Application No. DE 102019201148.9 filed on Jan. 30, 2019, which is expressly incorporated herein by reference in its entirety.

### FIELD

The present invention relates to a sensor device for a vehicle and a method for manufacturing such a sensor device.

### BACKGROUND INFORMATION

Sensor devices are often used in vehicles to detect measured variables in vehicle surroundings. Such a sensor device, which may be designed, for example, as a rear view camera, is generally accommodated in a housing including further electrical components and a circuit board.

An imager module for a vehicle camera is described, for example, in German Patent Application No. DE 10 2014 217 295 A1, the module including a lens holder, an objective lens, and a flexible conductor unit. The lens holder is formed in this case in particular as an injection molded part.

The background of the present invention is that the number of sensors installed in vehicles is continuously increasing. To nonetheless keep the additional cost for these sensors low, it is important to minimize the costs for such sensors.

It is an object of the present invention to provide a sensor device which may be manufactured more easily and cost-effectively.

### SUMMARY

The object may achieved by an example sensor device for a vehicle in accordance with the present invention and an example method for manufacturing such a sensor device in accordance with the present invention. Advantageous refinements of the present invention are described herein.

The present invention provides an example sensor device for a vehicle for detecting vehicle dimensions and/or pieces of vehicle surroundings information. The sensor device includes at least one sensor unit for measuring the corresponding vehicle dimensions and/or pieces of vehicle surroundings information, and a housing which at least partially encloses the sensor unit, the housing being formed at least partially by a ceramic casting compound, so that the housing may be manufactured in an unpressurized casting step, with exemption of sensor surfaces of the sensor unit.

The measured variable which is measured using the sensor unit is dependent on the utilized sensor unit. The sensor unit is accommodated in the housing and is at least partially enclosed thereby. An area of the housing via which the measured variables are detected is generally left exposed. The housing is made of a ceramic casting compound and is manufactured by way of a casting method.

The use of ceramic casting compound has the advantage in comparison to plastic, for example, that the ceramic casting compound is more cost-effective. The costs for such a sensor device may thus be reduced. Silicone elastomers are particularly preferably used as the ceramic casting compound. In comparison to an injection molding process using plastic, the ceramic casting compound may be used in an unpressurized casting step. A more cost-effective casting tool may thus be used. As with the injection molding process using plastic, sensor surfaces of the sensor unit may be left out with the ceramic casting compound. The sensor device may thus be manufactured more simply and cost-effectively.

In one preferred embodiment of the present invention, the sensor unit includes a camera sensor unit, a radar sensor unit, or an ultrasonic sensor unit. The vehicle surroundings may be detected in a simple manner using such sensor units.

In another preferred embodiment of the present invention, the sensor unit is at least partially extrusion coated by the ceramic casting compound, so that the sensor unit is held by the ceramic casting compound. The sensor unit particularly preferably includes an electronic circuit board, which is held in the ceramic casting compound and is completely enclosed thereby, so that a thermal contact is ensured. The sensor unit is thus at least partially embedded in the ceramic casting compound. Fasteners are thus not necessary to connect the sensor unit to the housing. Screw bosses thus do not have to be provided in the housing, for example. In addition, space is not required on the circuit board to connect it to the housing using a screw. This has the result that the sensor device may be formed smaller.

In addition, drilling does not have to be performed in the circuit board and in a screw boss, whereby process steps and installation space may be saved. The manufacturing process is again simplified in this way and may be carried out at lower costs. In addition, a better thermal contact between the sensor unit and the housing is provided by the embedding of the sensor unit in the ceramic casting compound, whereby the heat dissipation is improved.

In one advantageous refinement, the ceramic casting compound is formed in such a way that at least one screw hole for a fastening on a carrier construction may be introduced therein. The ceramic casting compound thus has a greater wall thickness at least on an intended side in which a screw hole is to be introduced. In addition, the material of the ceramic casting compound is selected in such a way that a screw screwed into the screw hole is held by the material. This has the advantage that the sensor device is fastenable in a simple manner on the vehicle.

The object of the present invention is additionally achieved by a method for manufacturing the sensor device according to the present invention. The method includes at least the steps of inserting a sensor unit into a casting mold and extrusion coating the sensor unit using a ceramic casting compound, so that a housing is formed which at least partially encloses the sensor unit.

The method for manufacturing the sensor device has the advantage that not only a single sensor unit may be extrusion coated using the ceramic casting compound, but rather the casting mold may include multiple shapes, so that multiple sensor units may be extrusion coated in one step using the ceramic casting compound. Such a sensor device may thus be manufactured more cost-effectively.

The sensor unit is advantageously extrusion coated in such a way that it is completely held in the ceramic casting compound. A sensor unit which is at least partially extrusion coated by the ceramic casting compound is obtained using such a method step. The advantages mentioned with respect to the corresponding feature of the sensor device are thus achieved.

Exemplary embodiments of the present invention are illustrated in the figure and explained in greater detail below.

### BRIEF DESCRIPTION OF THE DRAWING

The figure shows a section through an exemplary embodiment of a sensor device according to the present invention for a vehicle.

### DETAILED DESCRIPTION OF EXAMPLE EMBODIMENTS

A section through an exemplary embodiment of a sensor device according to the present invention for a vehicle is shown in the figure. In the exemplary embodiment shown here, the sensor device is designed as a camera, for example, as a rear view camera for a vehicle. The sensor device includes a sensor unit 14, which is designed in this exemplary embodiment as a camera sensor unit.

Sensor unit 14 is accommodated in a housing 18 of the sensor device. Housing 18 is formed by a ceramic casting compound. Housing 18 is formed by a casting mold in which sensor unit 14 is inserted and into which the ceramic casting compound is introduced.

Sensor unit 14 is formed from an image sensor 22, which is situated on a circuit board 26 and fastened thereon. An image signal of the surroundings may be recorded using image sensor 22. Sensor unit 14 is at least partially extrusion coated by the ceramic casting compound during the manufacturing method of the sensor device, so that sensor unit 14 is held by the ceramic casting compound.

Due to the extrusion coating of sensor unit 14, additional fasteners, such as screws, for example, are not necessary to fasten sensor unit 14. Sensor unit 14 may thus be formed to be smaller. In addition, the thermal contact between sensor unit 14 and the ceramic casting compound is improved.

An optical unit 30 is situated in front of image sensor 22, via which the image of the surroundings is focused on image sensor 22. Optical unit 30 is held via a metallic optic holder 34. Optic holder 34 is extrusion coated by the casting compound of housing 18 and fixed thereby. After an insertion of optical unit 30 into optic holder 34 and an alignment of optical unit 30 in relation to image sensor 22, it is connected via an adhesive seam 38 to housing 18. Fixing of optical unit 30 and sealing to the outside are thus achieved.

A plug receptacle 42, at which a plug is pluggable, is situated on a side of housing 18 opposite to optical unit 30. Plug receptacle 42 is connected to circuit board 26, so that the image signal recorded via image sensor 22 may be relayed to the vehicle. In addition, a screw hole 46 is situated on the side opposite to optical unit 30, via which the sensor device is fastenable on the vehicle via a screw.

What is claimed is:

1. A sensor device for a vehicle for detecting vehicle dimensions and/or pieces of vehicle surroundings information, the sensor device comprising:
at least one sensor unit configured to measure the vehicle dimensions and/or pieces of vehicle surroundings information; and
a housing which at least partially encloses the sensor unit with exemption of at least sensor surfaces of the sensor unit;
wherein the housing is at least partially formed by a ceramic casting compound so that the housing is manufactured in an unpressurized casting step.

2. The sensor device as recited in claim 1, wherein the sensor unit includes a camera sensor unit, or a radar sensor unit, or an ultrasonic sensor unit.

3. The sensor device as recited in claim 1, wherein the sensor unit is at least partially extrusion coated by the ceramic casting compound, so that the sensor unit is held by the ceramic casting compound.

4. The sensor device as recited in claim 1, wherein the sensor unit includes an electronic circuit board, which is held in the ceramic casting compound and is completely enclosed thereby, so that a thermal contact is ensured.

5. The sensor device as recited in claim 1, wherein the ceramic casting compound is formed in such a way that at least one screw hole for a fastening on a carrier construction may be introduced therein.

6. The sensor device as recited in claim 1, wherein the ceramic casting compound is a silicone elastomer.

7. A method for manufacturing a sensor device for a vehicle for detecting vehicle dimensions and/or pieces of vehicle surroundings information, the method comprising the following steps:
inserting a sensor unit into a casting mold, the sensor unit configured to measure the vehicle dimensions and/or pieces of vehicle surroundings information; and
extrusion coating the sensor unit using a ceramic casting compound, so that a housing is formed which at least partially encloses the sensor unit.

8. The method for producing a sensor device as recited in claim 7, wherein the sensor unit is extrusion coated in such a way that the sensor unit is completely held in the ceramic casting compound.

9. A vehicle including a sensor device for detecting vehicle dimensions and/or pieces of vehicle surroundings information, the sensor device comprising:
at least one sensor unit configured to measure the vehicle dimensions and/or pieces of vehicle surroundings information; and
a housing which at least partially encloses the sensor unit with exemption of at least sensor surfaces of the sensor unit;
wherein the housing is at least partially formed by a ceramic casting compound so that the housing is manufactured in an unpressurized casting step.
